(19) United States
(12) Patent Application Publication
(10) Pub. No.: US 2025/0164361 A1
(43) Pub. Date: May 22, 2025

(54) APPARATUS FOR FIXING SAMPLE AND MANUFACTURING METHOD THEREFOR

(71) Applicants: SEOUL NATIONAL UNIVERSITY R&DB FOUNDATION, Seoul (KR); INSTITUTE FOR BASIC SCIENCE, Daejeon (KR)

(72) Inventors: Jungwon PARK, Seoul (KR); Min-Ho KANG, Seoul (KR)

(21) Appl. No.: 18/294,111

(22) PCT Filed: Jun. 13, 2022
(86) PCT No.: PCT/KR2022/008324

§ 371 Date: Jan. 31, 2024

(30) Foreign Application Priority Data
Aug. 2, 2021 (KR) 10-2021-0101665

(51) Int. Cl. G01N 1/31

(52) U.S. Cl. CPC G01N 1/31; G01N 2001/315

(57) ABSTRACT

An apparatus for fixing sample and a manufacturing method therefor are provided. The apparatus for fixing sample according to the embodiments of the present invention comprises a substrate having a window hole, a first pattern disposed on the substrate and having a sample fixing hole, and a window layer disposed below the first pattern in the window hole. The sample fixing hole is disposed on the window layer. The method for manufacturing an apparatus for fixing sample comprises preparing a substrate having a first surface and a second surface, forming a first layer on the first surface and a second layer on the second surface, patterning the second layer to form a second pattern, etching the substrate using the second pattern as an etching mask to form a window hole exposing the first layer, patterning the first layer to form a first pattern having a sample fixing hole, and forming a window layer contacting the first pattern in the window hole. The sample fixing hole is formed at a position corresponding to the window hole.

### TECHNICAL FIELD

The present invention relates to an apparatus for fixing sample and a manufacturing method therefor.

### BACKGROUND ART

Cryogenic-electron microscopy (cryo-EM) is a frequently used method to determine the three-dimensional (3D) structure of proteins because it allows direct observation of protein structures. Additionally, the cryo-electron microscopy is increasingly being used to resolve the structural dynamics of protein molecules, including the effects of drug binding.

However, sample preparation procedures for the cryo-electron microscopy make it difficult to provide precise control over the ice thickness which can achieve image quality and structural resolution. Typically, extensive sample screening is required to identify good sample grids from a sample batch, which hinders the efficiency of high-throughput 3D structural analysis.

### DISCLOSURE

### Technical Problem

The present invention provides an apparatus for fixing sample having good performance.

The present invention provides a method for manufacturing the apparatus for fixing sample.

The other objects of the present invention will be clearly understood by reference to the following detailed description and the accompanying drawings.

### Technical Solution

An apparatus for fixing sample according to the embodiments of the present invention comprises a substrate having a window hole, a first pattern disposed on the substrate and having a sample fixing hole, and a window layer disposed below the first pattern in the window hole. The sample fixing hoe is disposed on the window layer.

The depth of the sample fixing hole may be controlled by controlling the thickness of the first pattern. The first pattern may have a plural of sample fixing holes.

The window layer may include at least one of graphene oxide, graphene, and molybdenum disulfide (MoS₂).

The apparatus for fixing sample may further comprise a second pattern disposed below the substrate. The window hole may be exposed by the second pattern.

The substrate may comprise a silicon substrate, and the first pattern and the second pattern may include at least one of silicon nitride, silicon oxide, and aluminum oxide.

A method for manufacturing an apparatus for fixing sample comprises preparing a substrate having a first surface and a second surface, forming a first layer on the first surface and a second layer on the second surface, patterning the second layer to form a second pattern, etching the substrate using the second pattern as an etching mask to form a window hole exposing the first layer, patterning the first layer to form a first pattern having a sample fixing hole, and forming a window layer contacting the first pattern in the window hole. The sample fixing hole is formed at a position corresponding to the window hole.

The first layer and the second layer may be formed simultaneously. The substrate may comprise a silicon substrate. The first layer and the second layer are formed of at least one of silicon nitride, silicon oxide, and aluminum oxide.

The window layer may be formed of at least one of graphene oxide, graphene, and molybdenum disulfide (MoS₂).

The depth of the sample fixing hole may be controlled by controlling the thickness of the first pattern. The first pattern has a plural of sample fixing holes.

### Advantageous Effects

An apparatus for fixing sample according to the embodiments of the present invention has good performance. For example, the apparatus for fixing sample can uniformly form vitreous ice for analysis objects such as biomolecules and finely control the thickness of the vitreous ice, and can be applied to cryogenic-electron microscopy to enable efficient and reliable image processing for 3D reconstruction of biomolecular structures.

### DESCRIPTION OF DRAWINGS

FIG. 1 shows an apparatus for fixing sample according to an embodiment of the present invention.

FIG. 2 shows a cross section taken along line A-A in FIG. 1.

FIGS. 3, 4, 5, 6, 7, 8, 9, and 10 show a method for manufacturing the apparatus for fixing sample according to according to an embodiment of the present invention.

FIG. 11 shows diverse depths of the sample fixing holes (microwells) in the apparatus for fixing sample.

FIG. 12 shows an example of the manufacturing process of the apparatus for fixing sample.

FIG. 13 shows Raman spectrum of the graphene oxide layer of the apparatus for fixing sample.

FIG. 14 shows the thickness of the ice layers formed in the sample fixing holes at different depths.

FIG. 15 shows a comparison of the concentration of biomaterials observed in the sample fixing holes of the apparatus for fixing sample and the microholes of the carbon grid.

### BEST MODE

Hereinafter, a detailed description will be given of the present invention with reference to the following embodiments. The purposes, features, and advantages of the present invention will be easily understood through the following embodiments. The present invention is not limited to such embodiments, but may be modified in other forms. The embodiments to be described below are nothing but the ones provided to bring the disclosure of the present invention to perfection and assist those skilled in the art to completely understand the present invention. Therefore, the following embodiments are not to be construed as limiting the present invention.

Terms like ‘first’, ‘second’, etc., may be used to indicate various components, but the components should not be restricted by the terms. These terms are only used to distinguish one element, component, region, layer or section from another element, component, region, layer or section. A first element, component, region, layer or section could be termed a second element, component, region, layer or section without departing from the teaching of the embodiments of the present invention. It will be understood that when an element is referred to as being “on” another element, it can be directly on the other element or intervening elements may be present therebetween.

The size of the element or the relative sizes between elements in the drawings may be shown to be exaggerated for more clear understanding of the present invention. In addition, the shape of the elements shown in the drawings may be somewhat changed by variation of the manufacturing process or the like. Accordingly, the embodiments disclosed herein are not to be limited to the shapes shown in the drawings unless otherwise stated, and it is to be understood to include a certain amount of variation.

The terminology used herein is for the purpose of describing particular embodiments only and is not intended to limit the invention. It is to be understood that the singular forms “a,” “an,” and “the” include plural references unless the context clearly dictates otherwise. It will be further understood that the terms “comprises” or “has,” when used in this specification, specify the presence of stated features, integers, steps, operations, elements, and/or components, but do not preclude the presence or addition of one or more other features, integers, steps, operations, elements, components, and/or groups thereof.

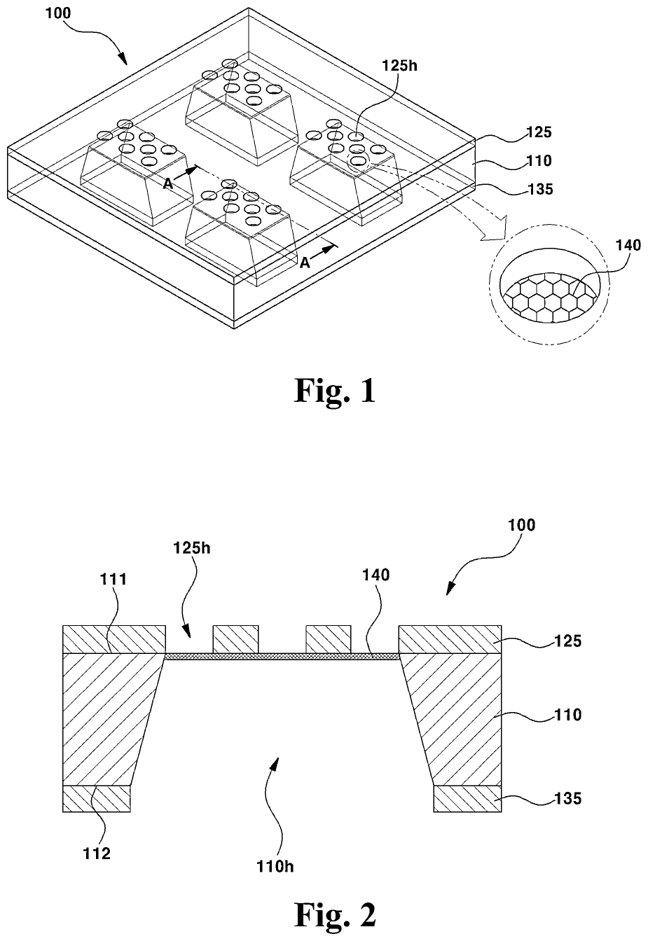

FIG. 1 shows an apparatus for fixing sample according to an embodiment of the present invention and FIG. 2 shows a cross section taken along line A-A in FIG. 1.

Referring to FIGS. 1 and 2, the apparatus for fixing sample 100 may comprise a substrate 110, a first pattern (sample fixing pattern) 125, a second pattern (mask pattern) 135, and a window layer 140.

The substrate 110 has a first surface 111 and a second surface 112 that are parallel to each other. The substrate 110 has a window hole 110h penetrating the substrate 110. For example, the substrate 110 may be formed of silicon and may have a thickness of 100 μm.

The first pattern 125 is disposed on the first surface 111 of the substrate 110 and has a sample fixing hole 125h for fixing the sample. A plural of sample fixing holes 125h may be disposed at a position corresponding to the window hole 110h. The first pattern 125 may have a thickness of tens to hundreds of nm. The depth of the sample fixing hole 125h is the same as the thickness of the first pattern 125, and the depth of the sample fixing hole 125h can be controlled by controlling the thickness of the first pattern 125. The sample fixing hole 125h may have, for example, a diameter of 2 μm. The sample fixing hole 125h may be disposed on the window layer 140 and function as a microwell. The sample fixing hole 125h can accommodate and fix various analysis objects. For example, the sample fixing hole 125h can accommodate and fix biomolecules, and a cryogenic-electron microscope can perform 3D imaging of the biomolecules. In addition, vitreous ice can be formed with a uniform thickness in the sample fixing hole 125h, enabling efficient and reliable image processing for 3D reconstruction of biomolecular structures.

The first pattern 125 may be formed by performing a chemical vapor deposition (CVD) process to form a first layer and then performing a photolithography process to pattern the first layer. The thickness of the first pattern 125 determines the depth of the sample fixing hole 125h, and the thickness of the first layer can be controlled by controlling the deposition time when depositing the first layer by the CVD process, thereby the thickness of the first pattern 125 can be controlled. For example, the first pattern 125 may be formed of at least one of silicon nitride, silicon oxide, and aluminum oxide. The first pattern 125 may be formed of the same material as the second pattern 135.

The second pattern 135 is disposed on the second surface 112 of the substrate 110 and has a hole corresponding to the window hole 110h. The second pattern 135 may function as an etching mask when etching the substrate 110 to form the window hole 110h. The second pattern 135 may be formed of a material that has a different etching selectivity with respect to the substrate 110. The second pattern 135 may be formed of the same material as the first pattern 125. For example, the second pattern 135 may be formed of at least one of silicon nitride, silicon oxide, and aluminum oxide. The second pattern 135 may be formed by performing a chemical vapor deposition (CVD) process to form a second layer and then performing a photolithography process to pattern the second layer.

The window layer 140 is disposed below the first pattern 125 in the window hole 110h. The window layer 140 contacts the lower surface of the first pattern 125 to enable the sample fixing hole 125h to function as a microwell. For example, the window layer 140 may be formed of at least one of graphene oxide, graphene, and molybdenum disulfide (MoS₂), and may have a thickness of 4 nm. For example, the window layer 140 may be formed by turning over the substrate so that the first pattern 125 is placed under the substrate and then providing the graphene oxide solution to the window hole 110h to transfer the graphene oxide to the first pattern 125.

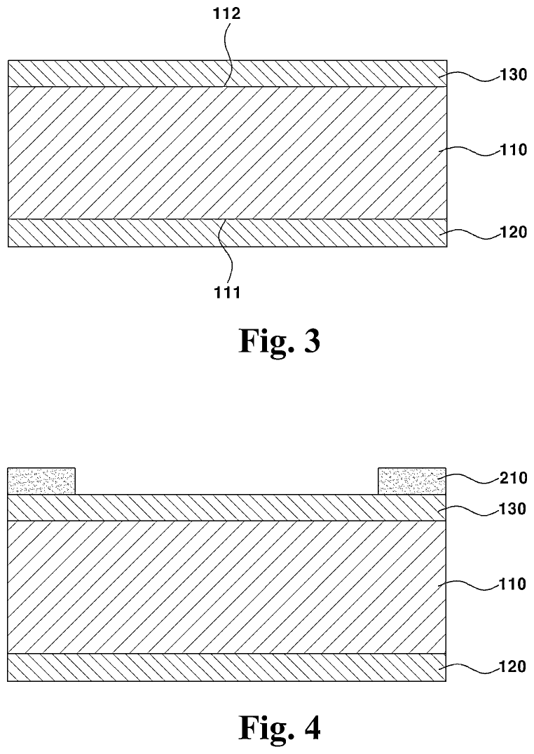

FIGS. 3 to 10 show a method for manufacturing the apparatus for fixing sample according to according to an embodiment of the present invention.

Referring to FIG. 3, a first layer 120 is formed on the first surface 111 of the substrate 110, and a second layer 130 is formed on the second surface 112 of the substrate 110. The substrate 110 may be a silicon substrate and may have a thickness of 100 μm. In this embodiment, the first layer 120 and the second layer 130 are formed simultaneously, but they are not limited to this and may be formed sequentially. The first layer 120 and the second layer 130 may be formed of at least one of silicon nitride, silicon oxide, and aluminum oxide by performing a chemical vapor deposition process. The thickness of the first layer 120 and the second layer 130 can be controlled by the deposition time of the chemical vapor deposition process. The first layer 120 and the second layer 130 may have a thickness of tens to hundreds of nm.

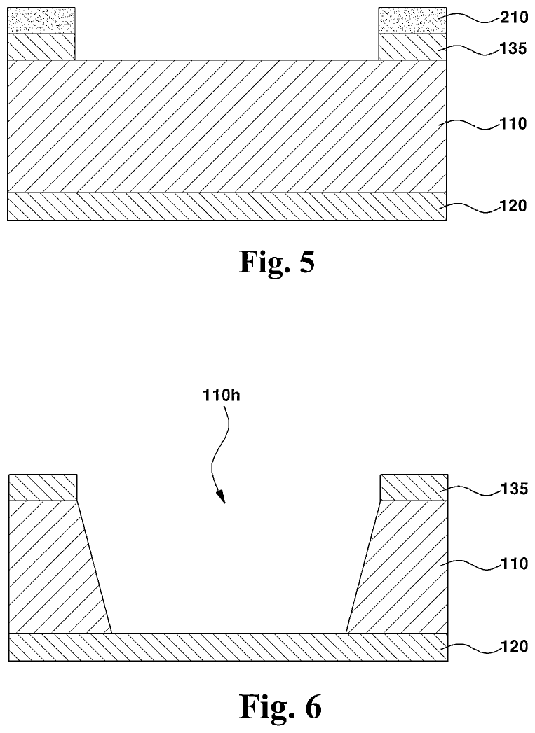

Referring to FIGS. 4 and 5, a photoresist pattern 210 is formed on the second layer 130, and the second layer 130 is etched using the photoresist pattern 210 as an etching mask to form a second pattern 135. The substrate 110 is exposed by the second pattern 135.

Referring to FIG. 6, the photoresist pattern 210 is removed, and the substrate 110 is etched using the second pattern 135 as an etching mask to form a window hole 110h penetrating the substrate 110. The first layer 120 is exposed by the window hole 110h.

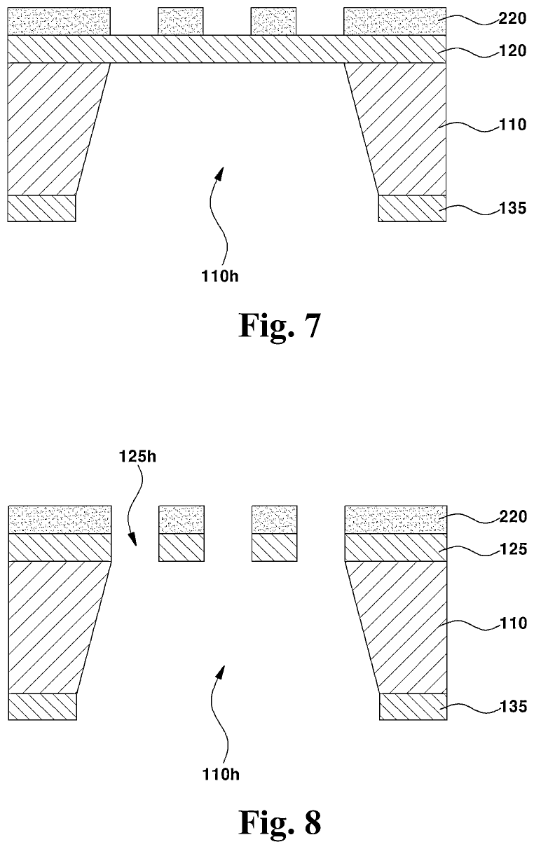

Referring to FIGS. 7 and 8, the substrate 110 of FIG. 6 is turned over and a photoresist pattern 220 is formed on the first layer 120, and the first layer 120 is etched using the photoresist pattern 220 as an etching mask. A first pattern 125 having a sample fixing hole 125h is formed by the etching. The sample fixing hole 125h may have a diameter of 2 μm, and the depth of the sample fixing hole 125h is equal to the thickness of the first pattern 125. A plural of sample fixing holes 125h may be formed at a position corresponding to the window hole 110h.

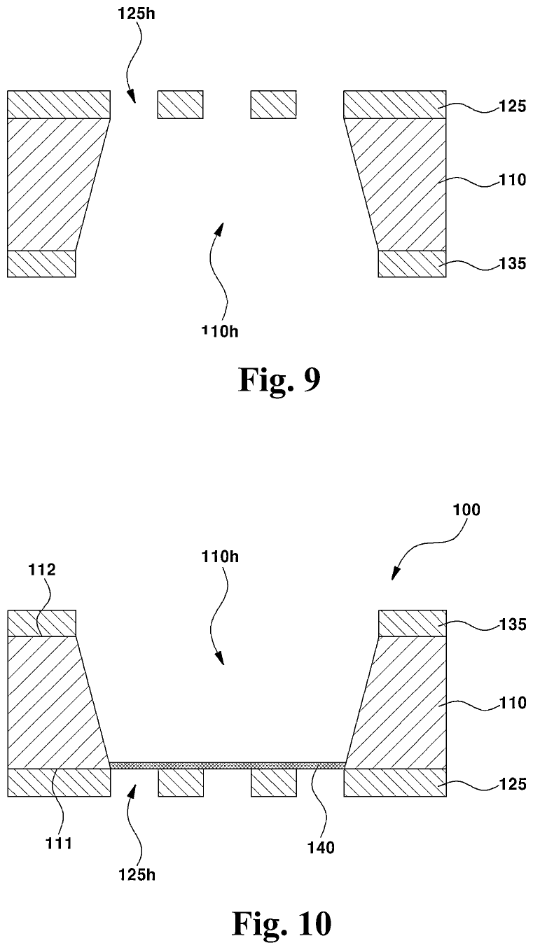

Referring to FIGS. 9 and 10, after removing the photoresist pattern 220, the substrate 110 is turned over and a window layer 140 is formed on the first pattern 125 in the window hole 110h. For example, the window layer 140 may be formed of at least one of graphene oxide, graphene, and molybdenum disulfide (MoS₂). For example, the window layer 140 may be formed by providing a graphene oxide solution to the window hole 110h and transferring the graphene oxide to the first pattern 125.

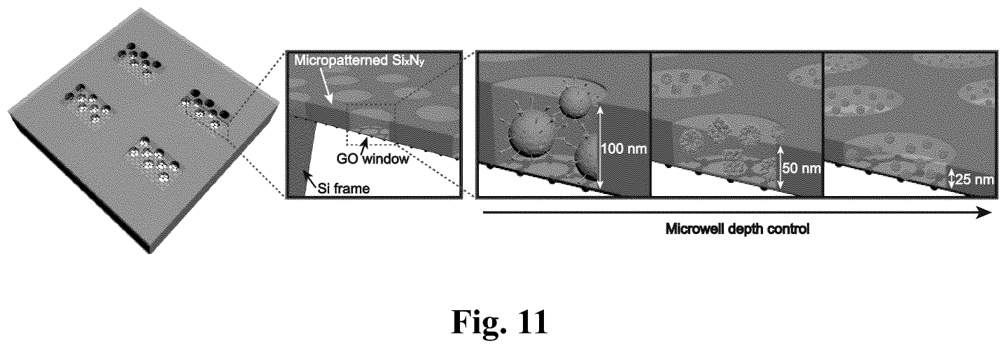

FIG. 11 shows diverse depths of the sample fixing holes (microwells) in the apparatus for fixing sample.

Referring to FIG. 11, a silicon nitride pattern having sample fixing holes (microwells) filled with samples to be analyzed may be formed to have a controlled thickness, such as 25 nm, 50 nm, 100 nm. The depth of the sample fixing hole (microwell) can be controlled by controlling the thickness of the silicon nitride pattern (Micropatterned SiₓN_{y}), thereby the thickness of the vitreous ice formed in the sample fixing hole (microwell) can be easily adjusted according to the size of the material to be analyzed.

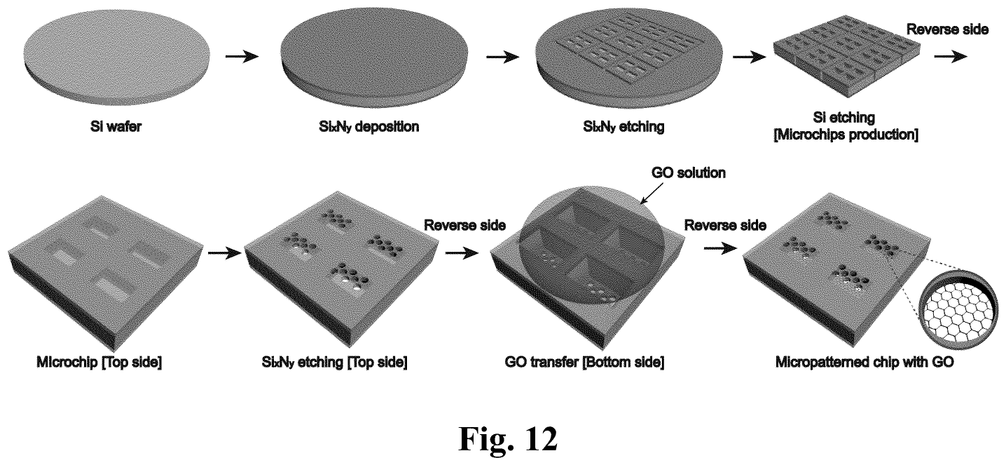

FIG. 12 shows an example of the manufacturing process of the apparatus for fixing sample.

Referring to FIG. 12, the apparatus for fixing sample can be formed using MEMS (micro-electro-mechanical system) technology and a 2D nanosheet transfer method. The apparatus for fixing sample can be easily mass-produced using silicon nitride patterns. For example, approximately 500 apparatuses can be produced from a single silicon wafer having 4-inch diameter using photolithography processes and dry and wet etching processes.

Silicon nitride layers (SiₓN_{y}) are formed by performing a low pressure chemical vapor deposition (LPCVD) process on both surfaces (a first surface and a second surface) of a silicon wafer with a thickness of 100 μm. A first silicon nitride layer is formed on the first surface of the silicon wafer, and a second nitride layer is formed on the second surface. The thickness of the second silicon nitride layer determines the depth of the microwell (sample fixing hole) and can be controlled by the deposition time when depositing the silicon nitride layer by performing the LPCVD process. A silicon nitride layer with a thickness of tens of nanometers can be stably formed by the LPCVD process. In embodiments of the present invention, the silicon nitride layers are deposited at three thicknesses of 25 nm, 50 nm, and 100 nm.

HMDS (Hexamethyldisilazane) is spin-coated on the first silicon nitride layer using a spin coater at 3000 rpm for 30 seconds. The wafer is baked on a hot plate at 95° C. for 30 seconds to hydrophobically functionalize the wafer surface for good adhesion with the photoresist. A positive photoresist is spin-coated on the first silicon nitride layer. The photoresist-coated wafer is baked at 110° C. for 50 seconds. After patterning the photoresist, the silicon wafer is rinsed with deionized water and completely dried by blowing N₂ gas onto the wafer surface.

The first silicon nitride layer is patterned by performing reactive ion etching (RIE) with sulfur hexafluoride (SF₆) gas (3 sccm) at an RF power of 50 W to form a first silicon nitride pattern. After patterning the first silicon nitride layer, the photoresist is removed by placing the silicon wafer in acetone for 30 minutes. The silicon wafer is cleaned with deionized water. The silicon wafer is etched in a potassium hydroxide solution (KOH, 1.5M) at 80° C. using the first silicon nitride pattern as an etching mask to form a hole (window hole) penetrating the silicon wafer. The silicon wafer is rinsed with deionized water to remove KOH etching residue.

HMDS and photoresist are sequentially coated on the second silicon nitride layer, and then the photoresist is patterned. The second silicon nitride layer is patterned by performing reactive ion etching to form a second silicon nitride pattern. The second silicon nitride pattern has a sample fixing hole formed at a position corresponding to the window hole of the silicon wafer. The sample fixing hole has a diameter of 2 μm. The silicon wafer is immersed in NMP (1-methyl-2-pyrrolidinone) solution for 12 hours at 60° C. and washed with deionized water to remove the photoresist. Photoresist residue is completely removed by performing an O₂ plasma process using O₂ gas (100 sccm) at an RF power of 200 W.

A graphene oxide layer (graphene oxide window) is formed on the lower surface of the second silicon nitride pattern in the window hole. The sample fixing hole in the second silicon nitride pattern is blocked on one side with the graphene oxide layer and functions as a microwell. The graphene oxide layer can be formed by a drop casting method or a float casting method.

The drop casting method is as follows.

Graphene oxide (GO) solution (2 mg/ml) is diluted to 0.2 mg/ml with deionized water and sonicated for 10 min to break up the aggregates of graphene oxide sheets. The diluted solution is gently centrifuged at 300 g for 30 seconds. Before transferring the graphene oxide, the bottom surface of the apparatus on which the second silicon nitride pattern is formed is positively charged using a glow discharger at 15 mA for 30 seconds. 3 μl of the graphene oxide solution is dropped onto the glow-discharged surface of the apparatus. After 1 minute, the graphene oxide solution on the apparatus is wiped off with filter paper. The apparatus on which the graphene oxide layer is transferred is washed with deionized water, and the deionized water on the apparatus is also removed.

The float casting method is as follows.

Dispersant solution is prepared by mixing deionized water and methanol at 1:5 volume ratio. The graphene oxide solution was diluted to 0.2 mg/ml with the dispersant solution and sonicated for 10 minutes. Before transferring the graphene oxide, the bottom surface of the apparatus on which the second silicon nitride pattern is formed is positively charged using a glow discharger at 15 mA for 30 seconds. The glow-discharged apparatus is placed on a SUS mesh inside a Petri dish (6.5 cm in diameter) containing deionized water with the bottom of the apparatus facing upward. 1 ml of graphene oxide solution is applied to the surface of the deionized water in the Petri dish. The water is drained out at a drain rate of 1 ml/min using a peristaltic pump. After the deionized water is completely drained out, the apparatus onto which the graphene oxide has been transferred is dried at room temperature overnight.

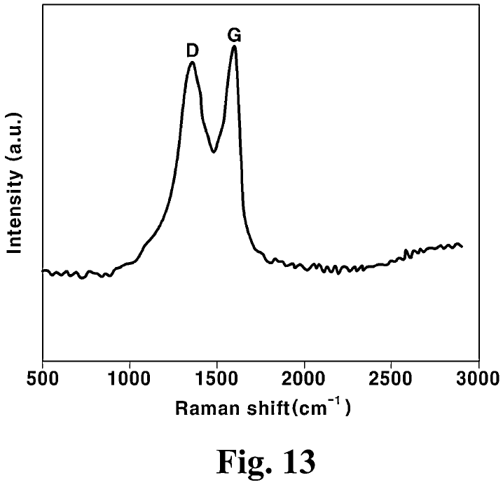

FIG. 13 shows Raman spectrum of the graphene oxide layer of the apparatus for fixing sample.

Referring to FIG. 13, the presence of a thin graphene oxide layer blocking the sample fixing hole is confirmed by a Raman spectrum. The Raman spectrum of the sample fixing hole region shows strong D and G bands at 1345 and 1602 cm⁻¹, respectively, with an I_{D}/I_{G} ratio of 0.99. The 1:1 ratio of D and G peaks is a characteristic of two-dimensional graphene oxide nanosheets. The average coverage of graphene oxide is measured to be 99.4±0.6% based on SEM observations. Forming a graphene oxide layer in an apparatus for fixing sample can ensure a high success rate in finding the optimal region for imaging. Additionally, because the sample fixing holes are arranged in a regular pattern, automated cryogenic-electron microscopy imaging over multiple holes can be used for bulk data collection.

Although not shown in the drawing, the graphene oxide layer is also confirmed by HRTEM image and electron diffraction patterns. The HRTEM images clearly show defect-free crystalline graphene oxide with measured lattice spacing of 0.25 nm which corresponds to the lattice spacing of graphene oxide. The thickness of the graphene oxide layer is measured at 4 nm, indicating multi-layers of graphene oxide. The 4 nm thick graphene oxide layer has no noticeable defect with a uniform contrast throughout the 2 μm sample fixing hole with minimal impact on TEM resolution, which is an important requirement for efficient cryogenic-electron microscopy imaging.

The thickness of the graphene oxide layer can be regulated depending on the graphene oxide transfer method and the concentration of the graphene oxide solution. Using a small amount of graphene oxide solution, drop casting can form a very flat graphene oxide layer with no visible wrinkles. The graphene oxide layer formed by drop casting is barely visible at even high defocus values due to its flatness and low background signal. The drop casting method ensures almost 100% coverage of graphene oxide over the apparatus for fixing sample. Float casting also forms graphene oxide layer with a high hole coverage of approximately 99.0% with a benefit of transferring graphene oxide to plural apparatuses in one transfer process.

An apparatus for fixing sample with a graphene oxide layer at three depths of 25, 50, and 100 nm of the sample fixing hole was fabricated and observed by SEM and TEM. The microwell structure defined by the sample fixing hole in the silicon nitride pattern and the graphene oxide layer was clearly visible in the SEM image, confirming the transfer of the graphene oxide layer. In addition, the thickness of the silicon nitride pattern was measured to be 28±2 nm, 48±2 nm, and 103±1 nm, confirming that the thickness of the silicon nitride pattern and the depth of the sample fixing hole were controlled.

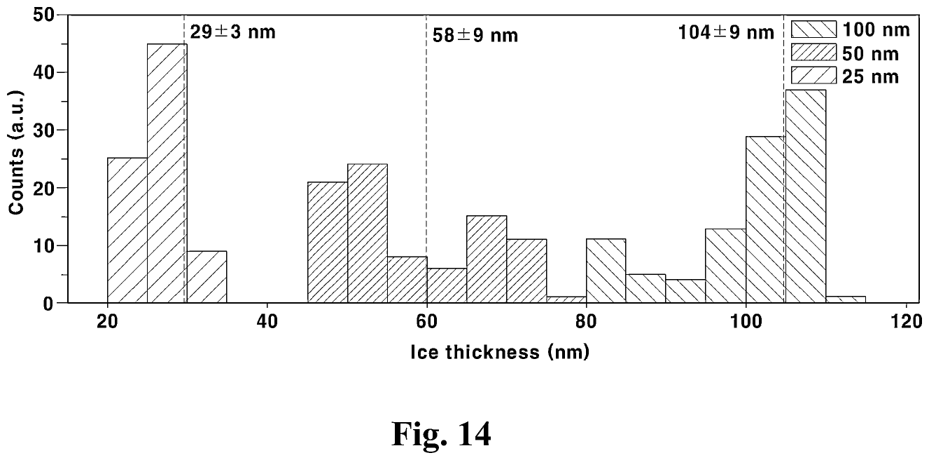

FIG. 14 shows the thickness of the ice layers formed in the sample fixing holes at different depths.

Referring to FIG. 14, the average thicknesses of the ices formed inside the sample fixing holes with depths of 25, 50, or 100 nm is 29±3 nm, 58±9 nm, or 104±9 nm, respectively, showing that the depth of the sample fixing hole can determine the thickness of the vitreous ice. In all three types of apparatuses with different sample fixing hole depths, the thickness of the vitreous ice is uniform throughout multiple holes in the apparatus for fixing sample, as indicated by the narrow distribution in the histograms for the measured thickness of the vitreous ice. Vitreous ice of a uniform accurate thickness can be formed using an apparatus for fixing sample having sample fixing holes (microwells) whose depth is adjusted. The thickness of the vitreous ice formed in the sample fixing hole of the apparatus for fixing sample was evaluated by energy filtered TEM (EFTEM), and a uniform thickness of vitreous ice was confirmed throughout the sample fixing hole region. The graphene oxide layer of the apparatus for fixing sample reduces the exposed water-air interface, enhancing the ice thickness uniformity. The uniform thickness of ice formed in the sample fixing hole enables efficient and reliable image processing for 3D reconstruction of biomolecular structures.

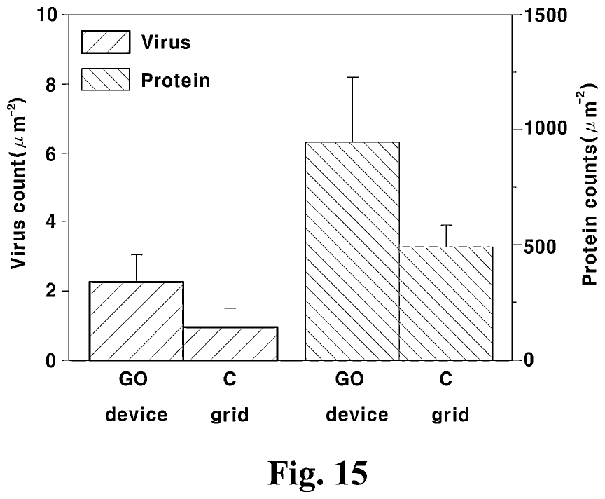

FIG. 15 shows a comparison of the concentration of biomaterials observed in the sample fixing holes of the apparatus for fixing sample and the microholes of the carbon grid. The number of biological entities (HIV-1 and groEL) captured in the graphene oxide layer of the apparatus for fixing sample was counted and compared to that obtained using microholes in a conventional carbon grid.

Referring to FIG. 15, the number density of HIV-1 particles in the sample fixing hole of the apparatus for fixing sample is 2/μm², while that in the hole of the carbon grid is only 1/μm². These difference is also consistently observed in cryogenic-electron microscopy imaging of groEL protein molecules. About 950 proteins are concentrated in the unit area (1 μm²) of the sample fixing holes of the apparatus for fixing sample during the sample preparation process, but only about 490 proteins per μm² are detected in the carbon grid.

Concentrating biomolecules in the imaging area of an apparatus for fixing sample can improve imaging for analyzing the biomolecular structure of a sample because it reduce the required number of images and the imaging time. Additionally, an apparatus for fixing sample with a graphene oxide layer can reduce the amount of biomolecules used, thereby reducing costs.

In addition to single biomolecular particles, diverse types of materials can be observed by the apparatus for fixing sample with the graphene oxide layer (graphene oxide window) by selecting sample fixing holes of different depths depending on the size of the material. For example, tau proteins fibrillized with heparin are visualized by cryogenic-electron microscopy using the apparatus for fixing sample with 100 nm depth sample fixing holes. The fibrillar morphology and width (about 10 nm) of tau proteins are almost identical to those observed in conventional cryogenic-electron microscopy, but exhibited more twisted contour, potentially suggesting more physiological states of tau fibrils. Additionally, inorganic materials such as Fe₂O₃ nanoparticles, Au nanoparticles (AUNPs), and silica nanoparticles can also be investigated using apparatuses with sample fixing holes of 100, 50, and 25 nm depth, respectively. The apparatus for fixing sample enables efficient and high-throughput 3D structural analysis by cryogenic-electron microscopy.

Although the embodiments of the present invention have been disclosed for illustrative purposes, those skilled in the art will appreciate that the present invention may be embodied in other specific ways without changing the technical spirit or essential features thereof. Therefore, the embodiments disclosed in the present invention are not restrictive but are illustrative. The scope of the present invention is given by the claims, rather than the specification, and also contains all modifications within the meaning and range equivalent to the claims.

### INDUSTRIAL APPLICABILITY

An apparatus for fixing sample according to the embodiments of the present invention has good performance. For example, the apparatus for fixing sample can uniformly form vitreous ice for analysis objects such as biomolecules and finely control the thickness of the vitreous ice, and can be applied to cryogenic-electron microscopy to enable efficient and reliable image processing for 3D reconstruction of biomolecular structures.

1. An apparatus for fixing sample comprising:
a substrate having a window hole;
a first pattern disposed on the substrate and having a sample fixing hole; and
a window layer disposed below the first pattern in the window hole,
wherein the sample fixing hoe is disposed on the window layer.

2. The apparatus for fixing sample of claim 1, wherein the depth of the sample fixing hole is controlled by controlling the thickness of the first pattern.

3. The apparatus for fixing sample of claim 1, wherein the first pattern has a plural of sample fixing holes.

4. The apparatus for fixing sample of claim 1, wherein the window layer includes at least one of graphene oxide, graphene, and molybdenum disulfide (MoS₂).

5. The apparatus for fixing sample of claim 1, further comprising a second pattern disposed below the substrate,
wherein the window hole is exposed by the second pattern.

6. The apparatus for fixing sample of claim 5, wherein the substrate comprises a silicon substrate, and
wherein the first pattern and the second pattern include at least one of silicon nitride, silicon oxide, and aluminum oxide.

7. A method for manufacturing an apparatus for fixing sample comprising:
preparing a substrate having a first surface and a second surface;
forming a first layer on the first surface and a second layer on the second surface;
patterning the second layer to form a second pattern;
etching the substrate using the second pattern as an etching mask to form a window hole exposing the first layer;
patterning the first layer to form a first pattern having a sample fixing hole; and
forming a window layer contacting the first pattern in the window hole,
wherein the sample fixing hole is formed at a position corresponding to the window hole.

8. The method of claim 7, wherein the first layer and the second layer are formed simultaneously.

9. The method of claim 7, wherein the substrate comprises a silicon substrate, and
wherein the first layer and the second layer are formed of at least one of silicon nitride, silicon oxide, and aluminum oxide.

10. The method of claim 7, wherein the window layer is formed of at least one of graphene oxide, graphene, and molybdenum disulfide (MoS₂).

11. The method of claim 7, wherein the depth of the sample fixing hole is controlled by controlling the thickness of the first pattern.

12. The method of claim 7, wherein the first pattern has a plural of sample fixing holes.
